(19) United States
(12) Patent Application Publication
(10) Pub. No.: US 2008/0059706 A1
(43) Pub. Date: Mar. 6, 2008

(54) Storage apparatus, storage system and control method for storage apparatus

(75) Inventor: Takao Aigo, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/896,061

(22) Filed: Aug. 29, 2007

(30) Foreign Application Priority Data
Sep. 6, 2006 (JP) 2006-242024

(51) Int. Cl. G06F 12/00

(52) U.S. Cl. 711/118; 711/E12.001

(57) ABSTRACT

A storage apparatus includes a host controller that receives a write request accompanied by write data, a cache unit that checks if space is available in any one of itself and a cache unit of an external apparatus, and a switch unit that outputs a request to store write data in the cache unit of the external apparatus, on condition that space is available not in the cache unit but in the cache unit of the external apparatus.

This application is based upon and claims the benefit of priority from Japanese patent application No. 2006-242024, filed on Sep. 6, 2006 the disclosure of which is incorporated herein in its entirety by reference.

### BACKGROUND OF THE INVENTION

1. Field of the Invention

The present invention relates to a storage apparatus, a storage system and a control method for the storage apparatus.

2. Description of the Related Art

Japanese Patent Application Laid-open Publication No. 2005-284343 discloses a storage apparatus with a redundant disk array unit, in which a first disk-array control unit is capable of using a cache memory of a second disk-array control unit.

In this storage apparatus, a plurality of disk-array control units are each provided with a cache memory. In addition, the cache memory stores, therein, cache memory management information for managing the allocation of the cache memory.

One of the disk-array control units uses, as a part of the cache memory of its own, a part of the cache memory of another one of the disk-array control units, by allocating the cache memory with the cache memory management information.

### SUMMARY OF THE INVENTION

An exemplary object of the present invention is to provide a storage apparatus, a storage system and a control method for the storage apparatus, which may resolve the problem of deterioration in performance.

A storage apparatus according to an exemplary aspect of the invention includes a host controller that receives a write request accompanied by write data, a cache unit that checks if space is available in any one of itself and a cache unit of an external apparatus, and a switch unit that outputs a request to store write data in the cache unit of the external apparatus, on condition that space is available not in the cache unit but in the cache unit of the external apparatus.

A control method for a storage apparatus including a cache unit according to an exemplary aspect of the invention includes storing write data in a cache unit of a external apparatus, upon receipt of a write request accompanied by the write data while space is available not in the cache unit but in the cache unit of the external apparatus.

### BRIEF DESCRIPTION OF THE DRAWINGS

Exemplary features and advantages of the present invention will become apparent from the following detailed description when taken with the accompanying drawings in which:

FIG. 1 is an exemplary block diagram showing the configuration of a storage apparatus according to a first exemplary embodiment;

FIG. 2 is an exemplary block diagram showing the configuration of a storage system according to a second exemplary embodiment;

FIG. 3 is an exemplary block diagram showing the configuration of a cache unit;

FIG. 4 is an explanatory diagram showing an example of a directory;

FIG. 5 is an explanatory diagram showing an example of a cache management table;

FIG. 6 is an explanatory diagram showing an example of an external writing management table in apparatus 0;

FIG. 7 is an explanatory diagram showing an example of an external reception management table in apparatus 0;

FIG. 8 is an exemplary flowchart showing an operation of the storage system;

FIG. 9 is an exemplary flowchart showing another operation of the storage system;

FIG. 10 is an exemplary flowchart showing yet another operation of the storage system;

FIG. 11 is an exemplary flowchart showing still another operation of the storage system; and

FIG. 12 is an exemplary flowchart showing even still another operation of the storage system.

### DESCRIPTION OF THE EXEMPLARY EMBODIMENTS

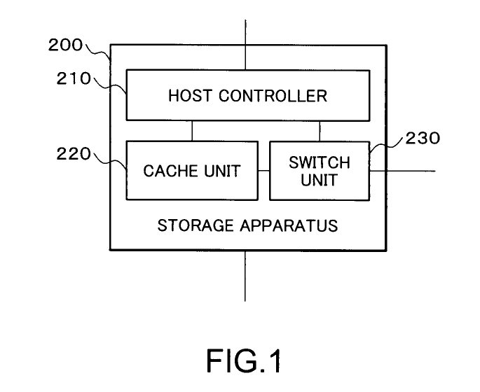

Next, a detailed explanation will be given for a first exemplary embodiment with reference to the drawings. FIG. 1 is an exemplary block diagram showing the configuration of storage apparatus 200 of the first exemplary embodiment.

As shown in FIG. 1, storage apparatus 200 includes host controller 210, cache unit 220 and switch unit 230.

Storage apparatus 200 is connected to a host computer and the like via host controller 210. Additionally, storage apparatus 200 is connected to an external apparatus via switch unit 230 storage apparatus 200 is also connected to an external storage. It is also possible to configure storage apparatus 200 to include an external storage therein as a storage unit.

Examples of the external storage include a physical disk or a memory. Cache unit 220 stores therein a part of data stored in the external storage. Cache unit 220 manages free space in cache unit 220 and that in a cache unit of the external apparatus. Host controller 210 receives a write request accompanied by write data, from the host computer and the like.

Upon receipt of the write request, cache unit 220 checks itself if space is available to store the write data. On condition that space is available, cache unit 220 stores the requested write data in itself.

Here, “space is available” indicates that the available capacity is equal to or more than a preset reference value.

On condition that space is available not in cache unit 220 but in the cache unit of the external apparatus, switch unit 230 outputs a cache-write request for storing the write data in the cache unit of the external apparatus. If the cache unit 220 cannot find any space available neither in itself nor in the cache unit of the external apparatus, cache unit 220 expels data stored therein to the external storage, and stores the requested write data in itself.

When switch unit 230 receives a cache-write request from the external apparatus, cache unit 220 stores the write data in itself.

Now assume a case where the write data are already written in the cache unit of the external apparatus. In this case, when host controller 210 receives a write request for an address (hereinafter, referred to as cache-storage unit address) of the write data, cache unit 220 checks itself if space is available. If cache unit 220 has available space, switch unit 230 outputs, to the external apparatus, a cache-read request accompanied by a delete request and an address.

Thereafter, when switch unit 230 receives, from the external apparatus, cache-storage unit data in response to the cache-read request, cache unit 220 stores the cache-storage unit data in itself.

In contrast, in a case where switch unit 230 receives a cache-read request accompanied by a delete request and an address, cache unit 220 reads cache-storage unit data. Thereafter, switch unit 230 outputs the read cache-storage unit data to the external apparatus that output the cache-read request. Additionally, cache unit 220 deletes the read cache-storage unit data from itself.

Here, cache-storage unit data means an amount of data corresponding to a single entry in cache unit 220.

Next, explanations will be given for advantages of the first exemplary embodiment.

In the technique disclosed in Patent Application Laid-open Publication No. 2005-284343, a storage apparatus is configured so that two disk-array control-units each provided with a cache memory are disposed therein. A first disk-array control-unit is allowed to use a cache memory of the second disk-array control-unit. However, since this technique does not relate to a plurality of storage apparatuses, one storage apparatus may not use a cache of another storage apparatus.

Accordingly, this technique has a first problem that the performance of the cache may not be enhanced in a case where a storage apparatus has only one disk-array control-unit.

Moreover in this technique, when data are already written in the cache memory of the second disk-array control-unit, the first disk-array control-unit may not be allowed to rewrite the data from the second cache memory to the cache memory of the first disk-array control-unit, even when space is available in the first cache memory.

Consequently, this technique may have a second problem of performance deterioration that happens in the cases of accessing to data using the cache memory of the second disk-array control-unit despite the space available in the cache memory of the first disk-array control-unit.

Storage apparatus 200 of the first exemplary embodiment resolves the above problems, and may have an advantageous effect of enhancing the performance of the storage apparatus.

One of the reasons for the advantage may be that each of a plurality of storage apparatuses 200 is allowed to use the cache unit of another storage apparatus 200.

Another one of the reasons for the advantage may be that upon receipt of a write request for a cache-storage unit address of write data stored in the cache unit of the external apparatus, storage apparatus 200 retrieves the cache-storage unit data from the external apparatus and stores the data in cache unit 220. For these reasons, for example, when a read request is received from a host computer and the like at a later time, reading data from cache unit 220 may be faster than reading data from the cache unit of the external apparatus.

Next, a detailed explanation for storage system 500 of a second exemplary embodiment will be given with reference to the drawings.

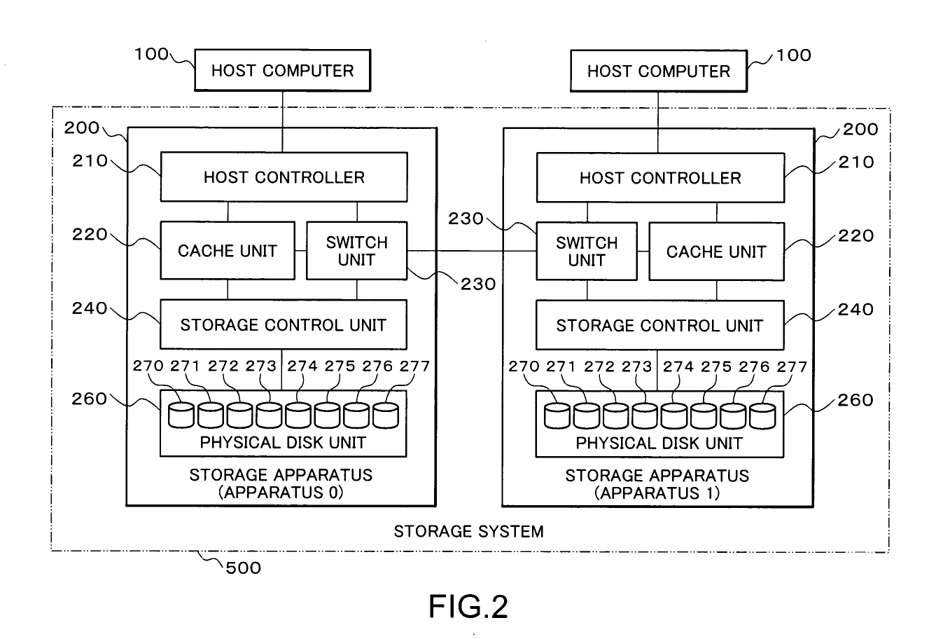

FIG. 2 is an exemplary block diagram showing the configuration of storage system 500 of the second exemplary embodiment.

As shown in FIG. 2, storage system 500 includes a plurality of mutually connected storage apparatuses 200. The number of storage apparatuses 200 is not limited.

In order to simplify the explanation, only two storage apparatuses 200 are shown in FIG. 2.

Storage apparatuses 200 are each referred to as apparatus 0 and apparatus 1. Apparatus 1 exists as a type of external apparatus (as explained in exemplary embodiment 1) for apparatus 0, and apparatus 0 exists as a type of external apparatus (as explained in exemplary embodiment 1) for apparatus 1.

Device 0 operates as taking apparatus 1 as an external apparatus, and apparatus 1 operates as taking apparatus 0 as an external apparatus.

Storage apparatuses 200 are connected to host computers 100, respectively. These storage apparatuses 200 are the same as that of the first exemplary embodiment. Storage apparatus 200 includes host controller 210, cache unit 220, switch unit 230, storage control unit 240 and physical disk unit 260.

Physical disk unit 260 is an exemplary implementation of the storage unit included in storage apparatus 200 of the first exemplary embodiment. Physical disk unit 260 of apparatus 0 includes physical disks 270, 271, . . . , 277, which are managed collectively as logical disks (such as logical disks Nos. 0 to 7). In addition, physical disk unit 260 of apparatus 1 includes physical disks 270, 271, . . . , 277, which are managed collectively as logical disks (such as logical disks Nos. 8 to 15).

Host computer 100 connected to apparatus 0 accesses logical disks 0 to 7 for data, while host computer 100 connected to apparatus 1 accesses logical disks 8 to 15 for data. Host computer 100 accesses the logical disks for data by one or more blocks.

Assume, for example, that a block is equivalent to 512 bytes. Cache unit 220 stores data to a cache entry by pages, a page being the unit in storing data in the cache. A page is supposed to be equivalent to 64 blocks, for example.

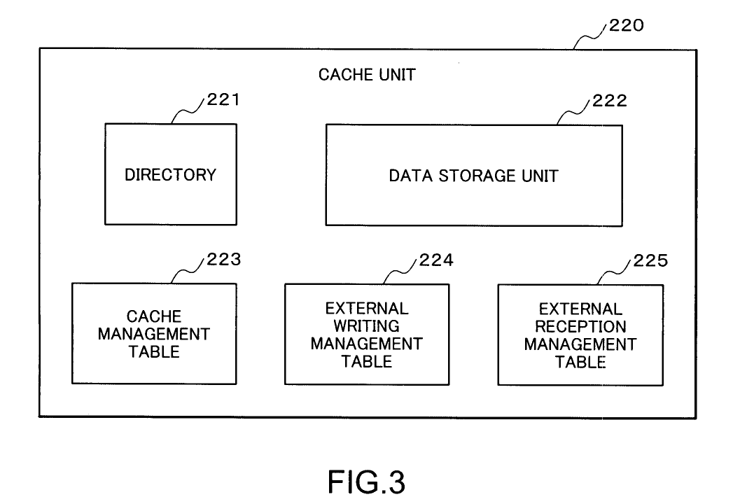

FIG. 3 is an exemplary block diagram showing the configuration of cache unit 220.

As shown in FIG. 3, cache unit 220 includes directory 221, data storage unit 222, cache management table 223, external writing management table 224 and external reception management table 225.

For each entry, directory 221 stores control information and a logical address. Data storage unit 222 stores a part of data stored in physical disk unit 260, by pages of each entry.

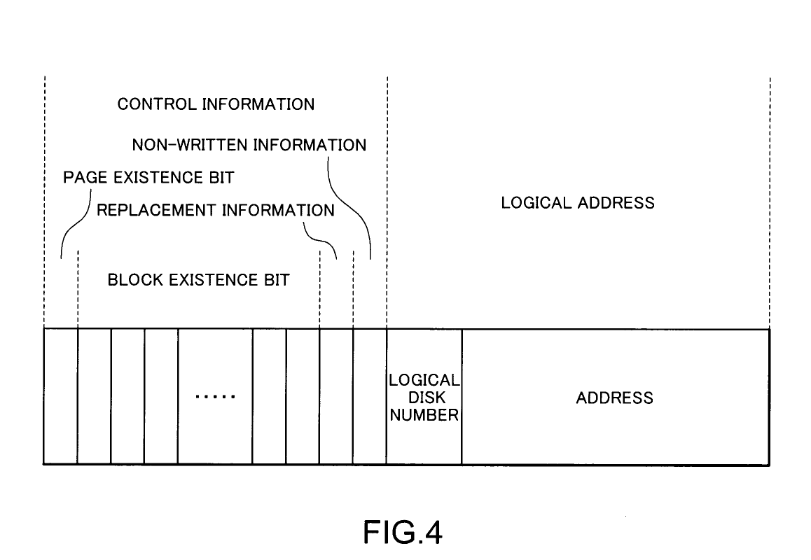

FIG. 4 is an explanatory diagram showing an example of directory 221.

As shown in FIG. 4, the control information includes page existence bit, block existence bits, replacement information and non-written information.

A block existence bit indicates whether the data of each block included in each page exist in data storage unit 222. When at least one block existence bit indicates the existence of the data of the block, page existence bit is set so as to indicate the effect. In addition, the replacement information is used in replacing data. A logical address includes a logical disk number and an address per page. The non-written information indicates whether the data has not yet been written in physical disk unit 260.

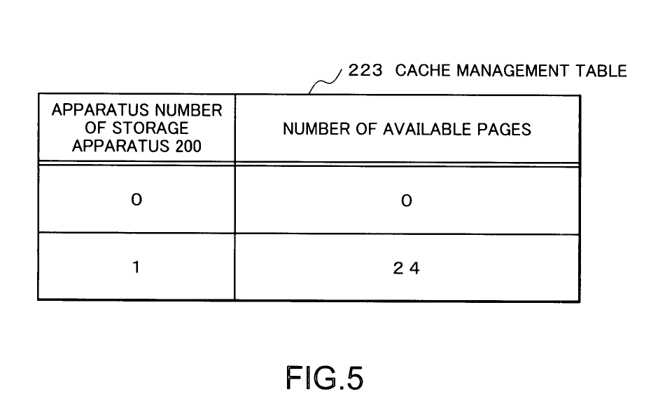

FIG. 5 is an exemplary diagram showing an example of cache management table 223.

As shown in FIG. 5, cache management table 223 includes apparatus numbers of storage apparatuses 200, and the number of available cache pages in the corresponding cache units 220. Here, available cache pages of storage apparatus 200 (apparatus 0) and storage apparatus 200 (apparatus 1) are 0 and 24 pages, respectively.

Although only information on apparatuses 0 and 1 are shown in FIG. 5 for simplification, cache management table 223 can otherwise include information on every connected storage apparatus 200.

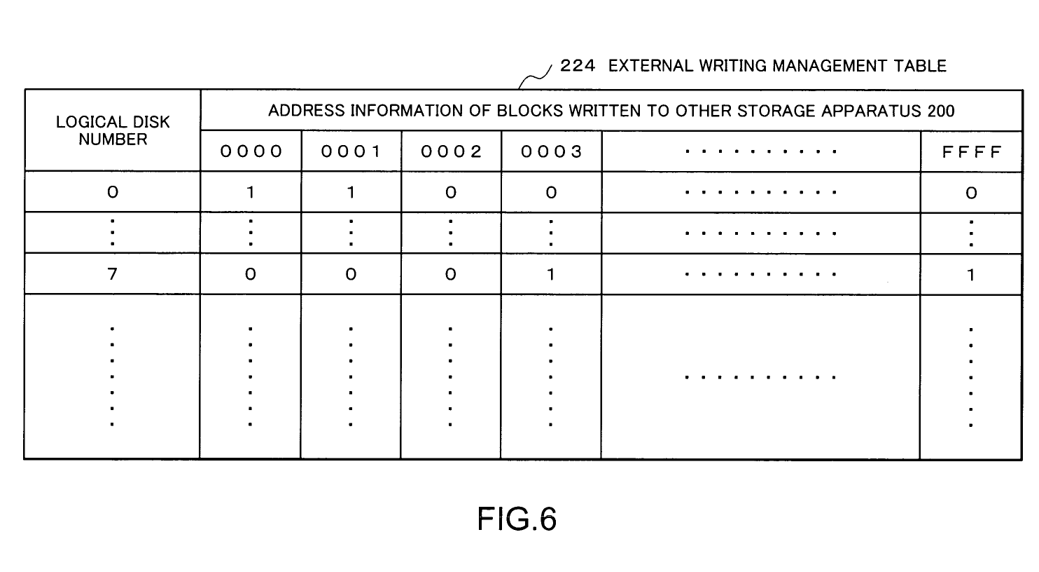

FIG. 6 is an explanatory diagram showing an example of external writing management table 224 in apparatus 0.

As shown in FIG. 6, external writing management table 224 includes logical disk numbers, and address information on data (in blocks) written to the other storage apparatus 200 (cache unit 220 thereof).

In FIG. 6, data of blocks 0 and 1 (each having the value “1”) in logical disk 0 (logical disk No. 0) are written in cache unit 220 of the other storage apparatus 200 (apparatus 1). Similarly, data of blocks 3 and FFFF (hex digit) (each having the value “1”) in logical disk 7 are written in cache unit 220 of the other storage apparatus 200 (apparatus 1).

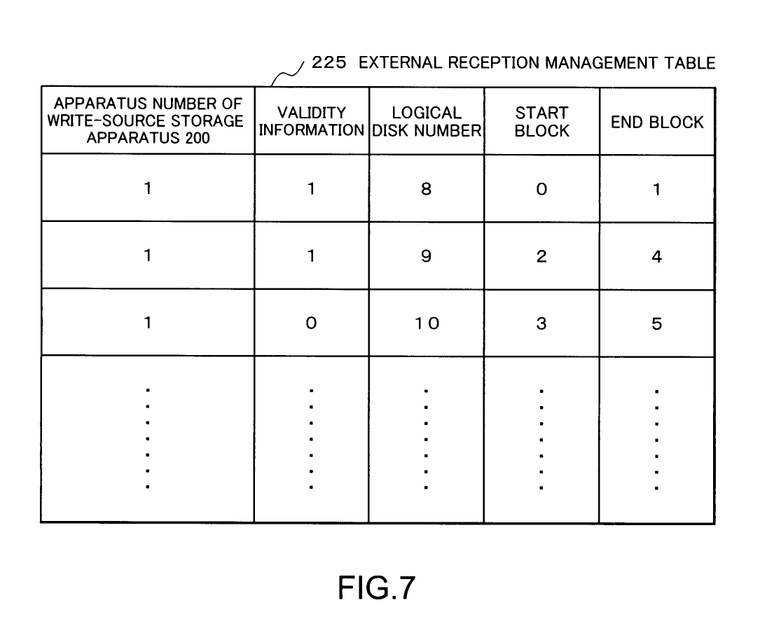

FIG. 7 is an explanatory diagram showing an example of external reception management table 225 in apparatus 0.

As shown in FIG. 7, external reception management table 225 includes the apparatus number of storage apparatus 200 that originally stores the data to be written (apparatus number of write-source storage apparatus 200), validity information, logical disk number, start block (address) and end block (address).

Cache unit 220 of apparatus 0 stores: data of two blocks, 0 and 1, that are originally stored in logical disk 8 of apparatus 1; and data of three blocks, 2 to 4, that are originally stored in logical disk 9 also of apparatus 1. If the validity information is set to “1” the data is valid, whereas “0” means that the data is invalid.

Although only information on apparatus 1 is shown in FIG. 7 for simplification, external reception management table 225 can otherwise include information on all of the other connected storage apparatuses 200.

Next, an explanation will be given for storage system 500 of the above configuration.

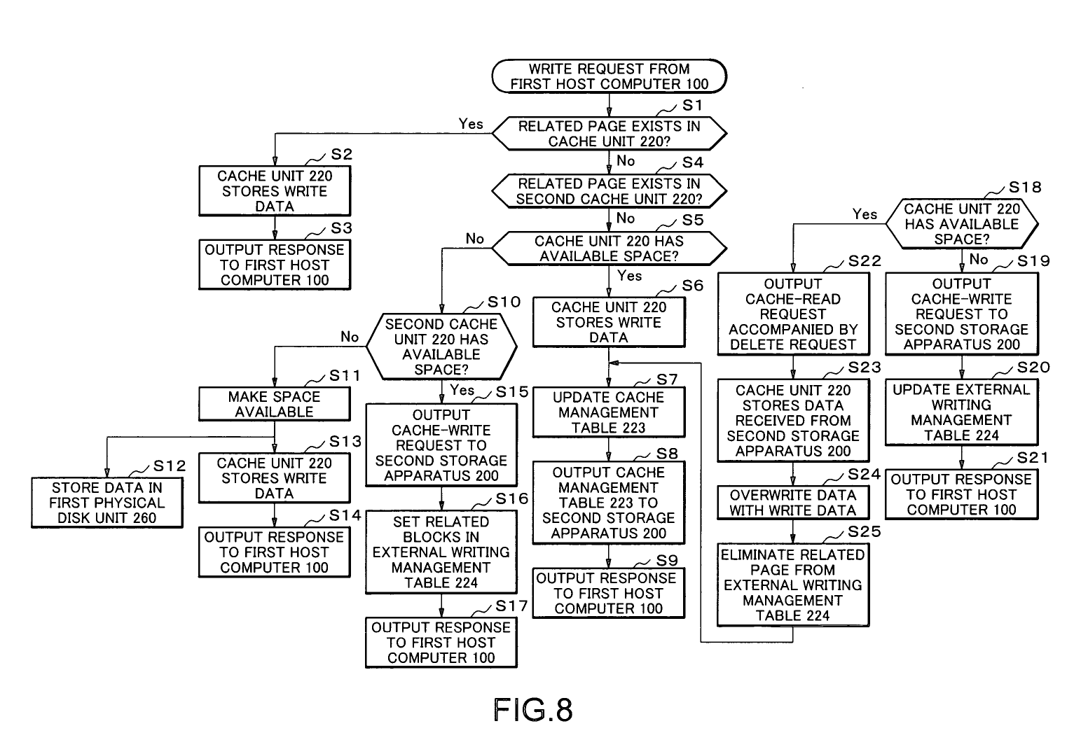

FIGS. 8 to 12 are exemplary flowcharts each showing an operation of storage system 500.

Hereinafter, storage apparatuses 200 will be referred to as first storage apparatus 200 and second storage apparatus 200, to avoid confusion. Components of each storage apparatus 200 will be referred to in the same manner. Note that, storage apparatus 200 and its components mentioned without first or second added thereto indicate the first storage apparatus 200 and its components, below.

Firstly, an explanation will be given for a write access operation by first host computer 100.

FIG. 8 is an exemplary flowchart showing the write access operation by first host computer 100.

As shown in FIG. 8, host controller 210 of storage apparatus 200 receives, from first host computer 100, a write request accompanied by write data (one or more blocks), the logical address, and block length. Then, cache unit 220 checks whether the page corresponding to the logical address of the received data exists in cache unit 220 itself (that is to say, in data storage unit 222), by referencing directory 221 (S1) If the page exists (page existence bit is set) (S1/Yes), cache unit 220 stores the write data in data storage unit 222 and sets the corresponding block existence bit (or bits) (S2). Next, host controller 210 outputs a response (indicating completion of writing) to first host computer 100 (S3).

If the page does not exist (page existence bit is not set) (S1/No), cache unit 220 checks whether the page exists in second cache unit 220 by referencing external writing management table 224 (S4). If the page does not exist in second cache unit 220 (S4/No), cache unit 220 checks if space is available in itself (that is, in data storage unit 222) by referencing cache management table 223.

If space is available (S5/Yes), cache unit 220 stores the write data in data storage unit 222, stores the logical address in directory 221, and sets the block existence bit(or bits), page existence bit and non-written information (S6). Cache unit 220 then updates cache management table 223 to lessen the number of available cache pages registered therein (S7).

Thereafter, switch unit 230 outputs the updated cache management table 223 to second storage apparatus 200 (S8) Host controller 210 then outputs a response (indicating completion of writing) to first host computer 100 (S9).

If cache unit 220 cannot find any space available in itself (S5/No), cache unit 220 checks if second storage apparatus 200 has available space by referencing cache management table 223 (S10)

If space is unavailable (S10/No), cache unit 220, by reference to the replacement information in directory 221, outputs data stored in data storage unit 222 (in pages) to storage control unit 240, in order to make space available (S11) In addition, storage control unit 240 stores the data transmitted from cache unit 220 (in pages) to first physical disk unit 260 (S12).

Next, cache unit 220 stores the write data in data storage unit 222, stores the logical address in directory 221, and sets the block existence bit (or bits) and non-written information (S13). Then, host controller 210 outputs a response (indicating completion of writing) to first host computer 100 (S14).

If second cache unit 220 has available space (S10/Yes), switch unit 230 outputs, to second storage apparatus 200, a cache-write request accompanied by write data, block length and the logical address (S15). Cache unit 220 then sets the corresponding block in external writing management table 224 (S16) After that, host controller 210 outputs a response (indicating completion of writing) to first host computer 100 (S17).

If the page exists in second cache unit 220 (S4/Yes), cache unit 220 checks if space is available in itself (that is, in data storage unit 222) by referencing cache management table 223 (S18).

If space is unavailable in data storage unit 222 (S18/No), switch unit 230 outputs, to second storage apparatus 200, a cache-write request accompanied by write data, block length and the logical address (S19). Thereafter, cache unit 220 updates the corresponding block in external writing management table 224 (S20) After that, host controller 210 outputs a response (indicating completion of writing) to first host computer 100 (S21).

If data storage unit 222 has available space (S18/Yes), switch unit 230 outputs, to second storage apparatus 200, a cache-read request accompanied by a delete instruction, the logical address and block length (S22). Upon receipt of data (in pages) from second storage apparatus 200 via switch unit 230, in response to the cache-read request, cache unit 220 stores the data in data storage unit 222 (S23).

Cache unit 220 then uses the write data received from first host computer 100 to overwrite the page of this same data in data storage unit 222. Cache unit 220 also sets the page existence bit in directory 221, the related block existence bit (or bits), replacement information and non-written information (S24). Then, cache unit 220 eliminates the related page from external writing management table 224 (S25). After that, storage apparatus 200 performs the operation of steps S7 to 9.

Hereinbelow, an explanation will be given for an operation for processing an access from second storage apparatus 200.

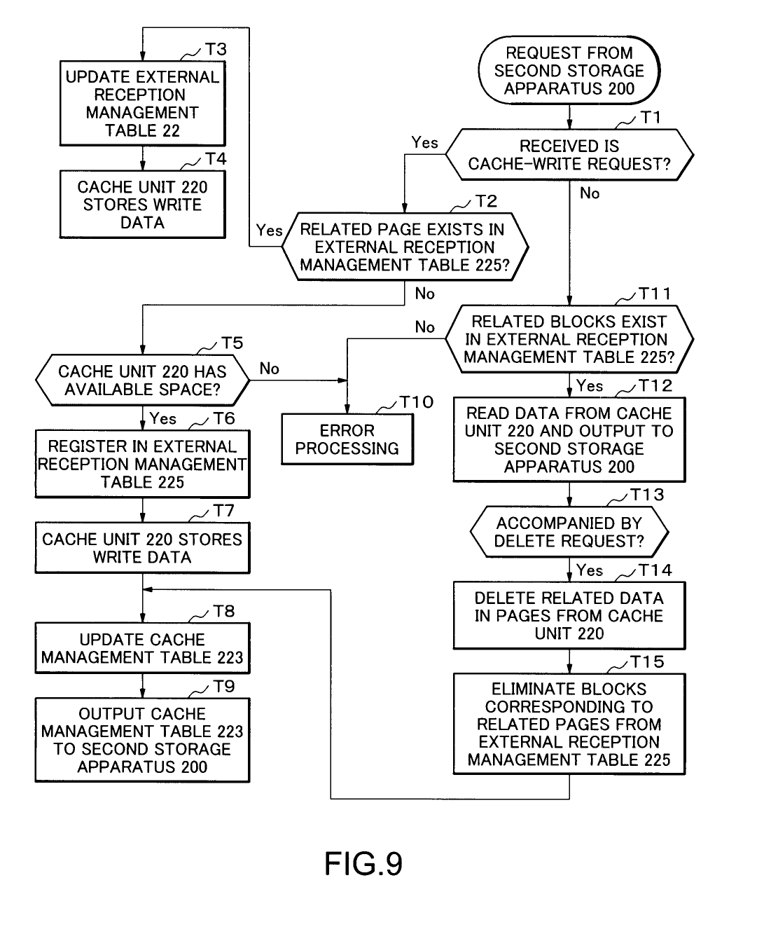

FIG. 9 is an exemplary flowchart showing the operation of access from second storage apparatus 200 As shown in FIG. 9, switch unit 230 of storage apparatus 200 receives a request from second switch unit 230 of second storage apparatus 200. Then, cache unit 220 checks the contents of the request. Upon receipt of a cache-write request accompanied by write data, block length and the logical address (T1/Yes), cache unit 220 checks external reception management table 225 (T2).

If the logical address indicates a page corresponding to a block that exists in external reception management table 225 (T2/Yes), cache unit 220 updates external reception management table 225 so as to include the block of received data (T3). Moreover, cache unit 220 updates directory 221 and stores the write data in data storage unit 222 (T4).

If the logical address does not indicate the page corresponding to the block that exists in external reception management table 225 (T2/No), cache unit 220 checks if space is available in itself (that is, in data storage unit 222) by referencing cache management table 223 (T5).

If space is available (T5/Yes), cache unit 220 registers, in external reception management table 225, a logical disk number, a start block, and an end block (T6) according to the logical address. Moreover cache unit 220 sets the validity information to “1”. Further, cache unit 220 stores the write data in data storage unit 222, stores the logical address in directory 221, and sets the block existence bit (or bits) for the related blocks, the page existence bit and replacement information (indicating that data is irreplaceable) (T7).

Cache unit 220 then updates cache management table 223 to lessen the number of free cache pages registered therein (T8) Thereafter, switch unit 230 outputs the updated cache management table 223 to second storage apparatus 200 (T9).

If space is unavailable in data storage unit 222 (T5/No), storage apparatus 200 performs error processing (T10). Upon receipt of a cache-read request accompanied by block length and the logical address (T1/No), cache unit 220 checks external reception management table 225 (T11).

If a block corresponding to the logical address exists in external reception management table 225 (T11/Yes), cache unit 220 reads the designated data in pages (though the designated data may be in blocks or pages) from data storage unit 222, and outputs the data to second storage apparatus 200 (T12).

Additionally, if the cache-read request is accompanied by a delete instruction (T13/Yes), cache unit 220 deletes the corresponding data in pages (T14). In other words, cache unit 220 resets all page existence bits and block existence bits corresponding to the pages in directory 221.

Cache unit 220 then eliminates, from external reception management table 225, the blocks corresponding to the pages (T15). That is to say, cache unit 220 sets the validity information of these pages to “0”. After that, storage apparatus 200 performs the processing of steps T8 and T9.

If the block corresponding to the logical address does not exist in external reception management table 225 (T11/No), storage apparatus 200 performs error processing (T10).

Hereinafter, an explanation will be given for the read access operation by first host computer 100.

Upon receipt of a read request, if data exists in cache unit 220, storage apparatus 200 reads data from cache unit 220 and outputs the data to first host computer 100.

If the data does not exist in cache unit 220, storage apparatus 200 checks whether the data exists in second cache unit 220 of second storage apparatus 200 by referencing external writing management table 224. If the data does not exist in second cache unit 220, storage apparatus 200 reads the data from physical disk unit 260, stores the data in cache unit 220, and further, outputs the data to first host computer 100. Additionally, cache unit 220 updates cache management table 223 and outputs the updated table to second storage apparatus 200.

Meanwhile, if the data exists in second cache unit 220, storage apparatus 200 outputs a cache-read request to second storage apparatus 200, receives the data from second storage apparatus 200, and outputs the data to first host computer 100.

Hereinbelow, an explanation will be given for the write-back operation of cache data.

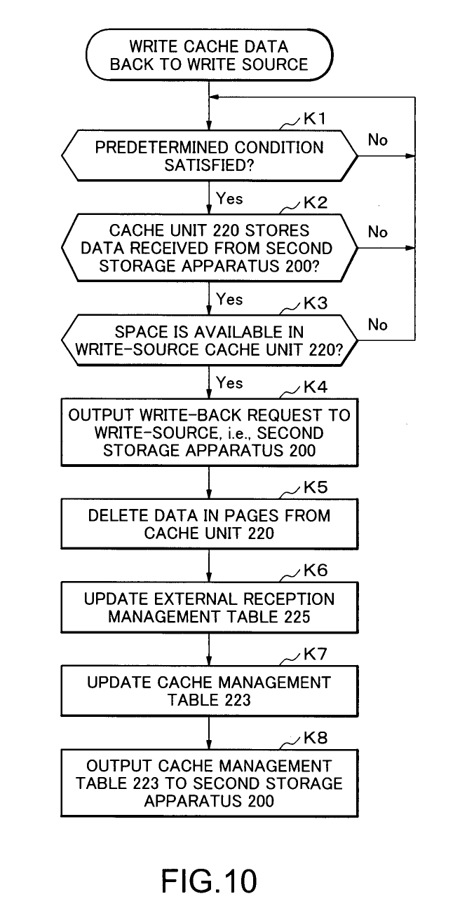

FIG. 10 is an exemplary flowchart showing the operation of writing cache data, back to the source in which the data was originally written (referred to as write source).

As shown in FIG. 10, when a predetermined condition is satisfied (for example, every time a certain period of time elapses) (K1/Yes), cache unit 220 checks whether data received from second storage apparatus 200 are stored in data storage unit 222, by referencing external reception management table 225 (K2).

If data received from second storage apparatus 200 are stored in itself (that is, in data storage unit 222) (K2/Yes), cache unit 220 checks if space is available in second cache unit 220 of second storage apparatus 200, which is the write source (K3). This check by cache unit 220 is carried out by reference to cache management table 223. If space is available in second cache unit 220 of second storage apparatus 200, which is the write source (K3/Yes), cache unit 220 outputs, to second storage apparatus 200, a write-back request accompanied by the logical address and data (in pages) (K4).

Cache unit 220 then deletes the data from itself (K5). Specifically, cache unit 220 resets the corresponding page existence bits and block existence bits in directory 221, and deletes the data (in pages) from data storage unit 222. Moreover, cache unit 220 updates external reception management table 225 by eliminating the related pages (K6), and updates cache management table 223 by increasing the number of available cache pages (K7). Thereafter, switch unit 230 outputs the updated cache management table 223 to second storage apparatus 200 (K8)

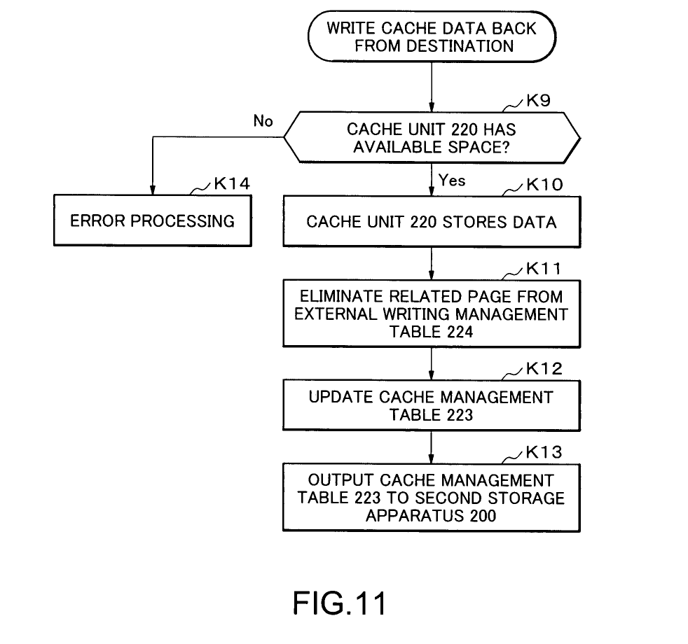

FIG. 11 is an exemplary flowchart showing the operation in which cache data is written back from the destination where the data was written (write destination).

As shown in FIG. 11, Upon receipt of a rewrite request accompanied by the logical address and data (in pages) from second storage apparatus 200, storage apparatus 200 checks if space is available in itself (that is, in data storage unit 222) by making cache unit 220 reference cache management table 223 (K9).

If space is available (K9/Yes), cache unit 220 stores the data in data storage unit 222, and sets the page existence bit, block existence bit (or bits), replacement information and non-written information, all of which are registered in directory 221 (K10). Cache unit 220 then eliminates the related pages in external writing management table 224 (K11).

Thereafter, cache unit 220 updates cache management table 223 to lessen the number of available cache pages registered therein (K12). Switch unit 230 then outputs the updated cache management table 223 to second storage apparatus 200 (K13). If space is unavailable (K9/No),” storage apparatus 200 performs error processing (K14).

Hereinafter, an explanation will be given for a write operation to physical disk unit 260.

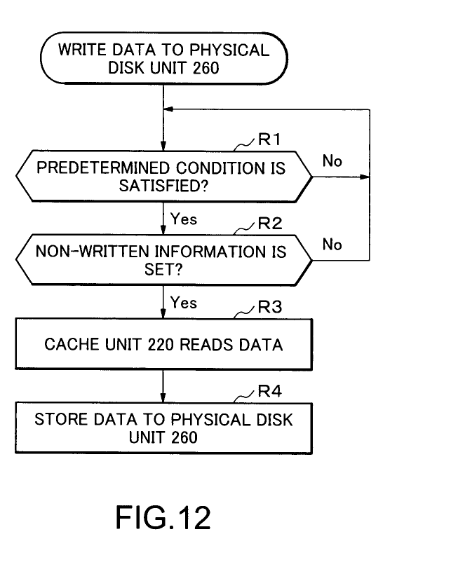

FIG. 12 is an exemplary flowchart showing the write operation to physical disk unit 260.

As shown in FIG. 12, when a predetermined condition is satisfied (for example, every time a certain period of time elapses) (R1/Yes), cache unit 220 checks the non-written information in directory 221 (R2).

If the non-written information is set (R2/Yes), cache unit 220 reads, from data storage unit 222, data for which the non-written information is set, and outputs the data together with its logical address to storage control unit 240 (R3). Upon receipt of the logical address and the data from cache unit 220, storage control unit 240 converts the logical address into a physical address and stores the data in physical disk unit 260 (R4).

In the abovementioned operations, upon receipt of second cache management table 223 from second storage apparatus 200, storage apparatus 200 updates cache management table 223 included therein.

Additionally, although a page is employed as the unit for cache storage in the abovementioned operations, a block may otherwise be employed as the unit. In this case, each entry in directory 221 of cache unit 220 should include a single block existence bit, while not including a page existence bit.

More over, when a predetermined condition is satisfied, cache unit 220 reads data from data storage unit 222 and stores the data in physical disk unit 260 in the abovementioned operations. However, the storage apparatus may be configured to perform control so that data are stored directly in physical disk unit 260, regardless of the predetermined condition. In this case, the non-written information need not be included in directory 221 of cache unit 220.

Storage system 500 of the second exemplary embodiment may have the advantageous effect of enhancing the performance thereof.

One of the reasons for the advantage may be that when access frequency of second host computer 100 is low, storage apparatus 200 is allowed to utilize a large part of cache unit 220 of second storage apparatus 200.

Another one of the reasons for the advantage may be that upon receipt of a write request for an address of a write data that is stored in second storage apparatus 200, storage apparatus 200 retrieves data from second storage apparatus 200 and stores the data in cache unit 220.

For example, when a read request is received from host computer 100 at a later time, reading data from cache unit 220 may be faster than reading data from second cache unit 220 of the external apparatus.

Still another one of the reasons for the advantage may be that storage apparatus 200 performs a write-back process when a predetermined condition is satisfied. In other words, storage apparatus 200 may write data stored in second storage apparatus 200, back in storage apparatus 200 where the data was originally written.

For example, when a read request is received from a host computer 100 at a later time, reading data from cache unit 220 is faster than reading data from second cache unit 220 of the external apparatus.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

Further, if is noted that the inventor's intent is to retain all equivalents of the claimed invention even if the claims are amended during prosecution.

What is claimed is:

1. A storage apparatus comprising:
a host controller that receives a write request accompanied by write data;
a cache unit that checks if space is available in any one of itself and a cache unit of an external apparatus; and
a switch unit that outputs a request to store write data in the cache unit of the external apparatus, on condition that space is available not in the cache unit but in the cache unit of the external apparatus.

2. The storage apparatus according to claim 1,
wherein when the host controller receives the write request for an address of write data stored in the cache unit of the external apparatus, the cache unit, on condition that space is available in the cache unit itself, retrieves the data stored in the cache unit of the external apparatus, and stores the data in the cache unit itself.

3. The storage apparatus according to claim 2,
wherein when the host controller receives a write request for an address of write data stored in the cache unit of the external apparatus, the cache unit, on condition that space is available in the cache unit itself, retrieves the data stored in the cache unit of the external apparatus, stores the data in the cache unit itself, and then overwrites the data with write data accompanying the write request.

4. The storage apparatus according to claim 3,
wherein the switch unit outputs, to the external apparatus, a cache-read request accompanied by a delete request, and receives, from the external apparatus, data in response to the cache-read request, and
the cache unit stores, in the cache-unit itself, the data received in the switch unit, and then overwrites the data with write data accompanying the write request.

5. The storage device according to claim 4,
wherein when the switch unit receives, from the external apparatus, the cache-read request accompanied by the delete request,
the cache unit reads data corresponding to the cache-read request and deletes the data from the cache unit itself, and
the switch unit outputs, to the external apparatus that has output the cache-read request, the data read by the cache unit.

6. The storage apparatus according to claim 5,
wherein the cache unit includes:
a cache management table that shows available storage space of the cache unit itself and of the cache unit of the external apparatus; and
an external writing management table that shows address information of data stored in the external apparatus,
wherein the cache unit checks if space is available in the cache unit of the external apparatus by referencing the cache management table, and checks data stored in the cache unit of the external apparatus by referencing the external writing management table.

7. The storage apparatus according to claim 6,
wherein the cache unit further includes:
an external reception management table that shows address information of data received from the external apparatus and stored in the cache unit itself,
wherein on detecting storage, in the cache unit itself, of data received from the external apparatus, which is the write source, and also detecting existence of available space in the cache unit of the external apparatus by referencing the cache management table, the cache unit reads, from the cache unit itself, the data received from the external apparatus, deletes the data in the cache unit itself, and updates the cache management table and the external reception management table; and
the switch unit outputs, to the external apparatus, a rewrite request accompanied by the data read from the cache unit.

8. The storage apparatus according to claim 7,
wherein when the switch unit, receives the rewrite request accompanied by data from the external apparatus, the cache unit stores, in the cache unit itself, the data received by the switch unit, and updates the external writing management table and the cache management table.

9. A storage system comprising:
a plurality of the storage apparatuses according to claim 1 connected to each other,
wherein each of the storage apparatuses operate as taking another storage apparatus as the external apparatus.

10. A control method for a storage apparatus including a cache unit, comprising:
storing write data in a cache unit of a external apparatus, upon receipt of a write request accompanied by the write data while space is available not in the cache unit but in the cache unit of the external apparatus.

11. The control method for a storage apparatus including a cache unit according to claim 10, further comprising:
retrieving data stored in the cache unit of the external apparatus, upon receipt of a write request for an address of write data stored in the cache unit of the external apparatus and on condition that space is available in the cache unit; and
storing the data in the cache unit.

12. The control method for a storage apparatus including a cache unit according to claim 11, further comprising:
overwriting the data with write data received with the write request.

13. The control method for a storage apparatus including a cache unit according to claim 12, further comprising:
outputting a cache-read request accompanied by a delete request to the external apparatus, upon receipt of the write request for the address of write data stored in the cache unit of the external apparatus;
storing, to the cache unit, data received from the external apparatus in response to the cache-read request; and
overwriting the data with the write data received with the write request.

14. The control method for a storage apparatus including a cache unit according to claim 13, further comprising:
reading data from the cache unit, upon receipt of the cache-read request accompanied by the delete request from the external apparatus;
outputting the data to the external apparatus that has output the cache-read request; and
deleting the output data from the cache unit.

15. A storage apparatus comprising:
host control means for receiving a write request accompanied by write data;
cache means for checking if space is available in the cache means itself and for checking if space is available in a cache unit of an external apparatus; and
switch means for outputting a request to store write data in the cache unit of the external apparatus, on condition that space is available not in the cache unit but in the cache unit of the external apparatus.

16. The storage apparatus according to claim 15,
wherein when the host control means receives a write request for an address of write data stored in the cache unit of the external apparatus, the cache means, on condition that space is available in the cache means itself, retrieves data stored in the cache unit of the external apparatus and stores the data in the cache means itself.
